(19) United States
(12) Patent Application Publication
(10) Pub. No.: US 2003/0165730 A1
(43) Pub. Date: Sep. 4, 2003

(54) Bipolar plate for a fuel cell

(76) Inventors: Hendrik Dohle, Stolberg-Mausbach (DE); Thomas Bewer, Aachen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/363,017

(22) PCT Filed: Aug. 2, 2001
(86) PCT No.: PCT/DE01/02959

(30) Foreign Application Priority Data
Sep. 1, 2000 (DE) 100 43 008.2

(51) Int. Cl. H01M 8/02

(52) U.S. Cl. 429/38; 429/39

(57) ABSTRACT

The invention relates to a bipolar plate for application in a fuel cell, comprising a channel forming structure. The bipolar plate further comprises, at least partly, a porous region, which borders a formed channel. According to the invention, in a fuel cell with the above bipolar plate, an improved distribution of the operating material under differing load conditions (high and low throughflow) with reduced pressure loss is made possible by means of the combination of channels and open pores within the porous region. The above regularly leads to an improved efficiency for the fuel cell.

The invention relates to a bipolar plate for use in a fuel cell or in a fuel cell stack, especially for use in a low-temperature fuel cell.

### STATE OF THE ART

A fuel cell stack is comprised of a plurality of individual fuel cells which are connected in succession over so-called bipolar plates. The bipolar plates form a gas-tight separation between anode compartments and the cathode compartments. They thus serve both as electrical current conductors as well as to distribute the corresponding operating media over the electrode surfaces.

For the distribution of the operating media differently structured bipolar plates are used.

From U.S. Pat. No. 4,988,583 a bipolar plate is known which is configured with channels running in a meander shape and which run partly parallel to one another. This kind of bipolar plate ensures both under conditions of low flow (partial load operation) and also at high flow rates (full load operation) good uniformity in the distribution of the operating media on the electrode surfaces.

A disadvantage of this structure however is that at high flow rates it has high pressure losses so that, as a compensation, the operating media must be supplied at high pressures. This is detrimental to the entire fuel cell system.

### OBJECT AND SOLUTION

The object of the invention is, starting from the state of the art, to provide a bipolar plate which in use in a fuel cell by itself will ensure under different load conditions of the fuel cell, a good uniformity of the distribution of the operating media with simultaneously a reduced pressure loss and thus, as a rule, a high operating efficiency.

The object is achieved with a bipolar plate according to the main claim as well as with a fuel cell according to the auxiliary claim. Advantageous embodiments will be found in the claims dependent thereon.

### THE SUBJECT OF THE INVENTION

The bipolar plate according to claim 1 has a channel-forming structure whereby this structure has at least one porous region bounding a channel.

By a channel-forming structure in the sense of the invention is to be understood a bipolar plate having at least one channel for the operating media. The bipolar plate alone, therefore, for example in the form of a tube, also together with the electrode can form a channel, for example via a comb-like structure. The channels formed by the bipolar plate effect advantageously a rapid distribution of the operating medium over the electrode bordering the bipolar plate.

By a porous region of the bipolar plate is to be understood that this region is comprised at least partly of a porous material with through-going porosity. When such a porosity region borders on a channel formed by the bipolar plate, thus the porous region not only effects a distribution of the operating medium within a porous region. Simultaneously the porous region enables as a rule, a reduction in the flow resistance to the throughflow of an operating medium.

A wire mesh for a conductive mat [fleece], for example a stainless steel fleece, can be mentioned by way of example as an advantageous suitable material for the porous regions. The material is conceived for use in a fuel cell. It gives no reaction with the operating media and is itself electrically conductive.

In a further embodiment the invention provides the porous regions of the bipolar plate at the locations at which contact with an electrode is to be provided. As a result, the supply of the electrode with the operating media can be ensured also at the locations at which the latter is in contact with the bipolar plate. At these contact points (ribs) between the bipolar plate and the electrode, there is usually only a slight electrochemical conversion in the state of the art since the operating media do not there reach the electrodes. With the bipolar plate of the invention, however, the operating media can flow through the open pores of the porous region and thus pass on to the electrodes.

In a further advantageous embodiment of the invention meandering-shaped canals are provided, especially for a fuel.

In a further advantageous embodiment of the bipolar plate, comb-like canals are provided especially for conveying the oxidizing agent. In both cases, advantageously, the ribs have the porous regions.

The ribs are the regions of the bipolar plate which are provided in a fuel cell for the contact with an electrode. The porous structure within the ribs effects, therefore, an especially good distribution of the fuel which does not pass directly into contact with electrode surfaces but also indirectly passes through the porous structure up to the electrode surfaces. Simultaneously the flow losses can be advantageously reduced.

Advantageously the bipolar plates according to the invention can be inserted into a fuel cell. In this case, two structures are used. Channels distribute an operating medium while at low flow rates but at high flow rates have high pressure losses. Open pores give rise at high flow rates only to limited pressure losses but however at reduced flow rates give only a poor distribution of the operating media.

The invention utilizes the advantages of both structures and obtains therewith an improved uniformity of distribution of the operating medium over all of the load conditions of a fuel cell while simultaneously reducing pressure losses.

### DESCRIPTION OF THE DRAWING

FIGS. 1 and 2 schematically show two embodiments of the bipolar plate according to the invention.

FIG. 1 is conceived especially advantageously for the anode region of a fuel cell. The white regions show the traditional meander-shaped arrangement of a fuel channel whereby the ribs are continuously according to the invention comprised of porous material. Analogously,

FIG. 2 shows an embodiment for the cavity compartment of a fuel cell. Through a comb structure of porous material, individual oxidizing agent channels are provided with exemplary embodiments.

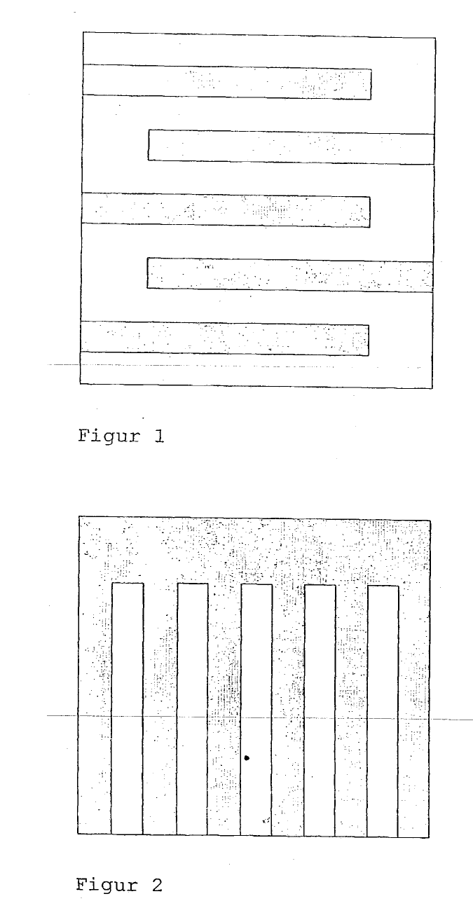

### EXAMPLES

### First Example

In a direct methanol fuel cell CO₂ is produced in the cavity compartment and becomes available as a gas. To discharge these CO₂ gas bubbles and to avoid flow losses, the anode compartment has to have a minimum dimension as the compartment height. With conventional gas distributor structures of a bipolar plate, the operating medium is directly fed to the electrode surfaces. The contact surfaces between the bipolar plate and the electrode surfaces (ribs) hardly contribute to conversion. With the bipolar plate according to the invention with porous structures in the regions of the ribs, the distribution of the drive medium is also effected below the ribs. The conversion can thus be increased and/or a more compact construction can be possible. Simultaneously, a more effective removal of the CO₂ bubbles is ensured.

### Second Example

With the previously described direct methanol fuel cell and polymer electrolyte membrane fuel cells, the problem arises that water is produced at the cavity side and water from the anode side passes through the membrane by electroosmosis or emerges from the electrolyte. This water plugs up as a rule, the channels on the cathode side so that transport limitations arise with respect to oxygen. The output and efficiency of the fuel cells are negatively influenced in a detrimental manner. With the distributor structure according to the invention of the bipolar plate, the cavity exhaust gas collecting channel can be eliminated and the water discharged over the entire surfaces to ensure an effective removal of the water. The embodiment according to FIG. 2 provides the possibility that the gas, in the case of plugged-up channels will be discharged through the hydrophobic porous region.

1. A bipolar plate for a fuel cell with at least one free channel for conducting an operating medium and at least one porous region bounding the channel, characterized in,
that the channel and the porous region are disposed in a plane and are provided for a direct contact with an electrode and
the porous region is configured to be traversed by an operating medium.

2. A bipolar plate according to the preceding claim with channel segments which run at least partly parallel to one another, in which all of the ribs between the channel segments are formed to be porous.

3. A bipolar plate according to one of the preceding claims 1 to 2, with a conductive fleece as the material for the porous regions.

4. A bipolar plate according to one of the preceding claims 1 to 3, with a meander-shaped channel for conducting an operating medium, especially for a fuel.

5. A bipolar plate according to one of the preceding claims 1 to 3, with a comb-shaped channel for conducting an operating medium, especially for an oxidizing medium.

6. A fuel cell with a bipolar plate according to one of the preceding claims 1 to 5.

7. A fuel call according to the preceding claims, in which the porous region and the free channel directly border on an electrode.
